(19) United States
(12) Patent Application Publication
(10) Pub. No.: US 2012/0297984 A1
(43) Pub. Date: Nov. 29, 2012

(54) GAS SEPARATION MEMBRANE FOR DME PRODUCTION PROCESS

(75) Inventors: Jong Tae Chung, Seoul (KR); Young Soon Baek, Incheon (KR); Won Jun Cho, Gyeonggi-do (KR); Young Sam Oh, Incheon (KR); Seong Yong Ha, Gyeonggi-do (KR); Hyung Chul Koh, Daejeon (KR); Chung Seop Lee, Daejeon (KR)

(73) Assignee: Korea Gas Corporation, Gyeonggi-do (KR)

(21) Appl. No.: 13/476,341

(22) Filed: May 21, 2012

(30) Foreign Application Priority Data
May 25, 2011 (KR) 10-2011-0049707

(51) Int. Cl. B01D 71/06; B01D 69/10; B01D 53/22; B01D 69/12; B01D 69/08

(52) U.S. Cl. 96/10; 96/11

(57) ABSTRACT

Disclosed herein is a gas separation membrane for a DEM production process, including: a porous support having a carbon dioxide permeability of more than 300 GPU (GPU=1×10⁻⁶ cm³/cm²·sec·cmHg) and an inner diameter of 100˜1000 μm; and a composite membrane provided on an inner or outer surface of the porous support and coated with a separating material having a permeation selectivity of carbon dioxide/hydrogen of 4 or more. The gas separation membrane is advantageous in that it can improve efficiency of the separation process by selectively separating and removing carbon dioxide from a gas mixture of carbon dioxide and hydrogen produced during a process of producing DME which is a next-generation clean fuel.

### CROSS-REFERENCE TO RELATED APPLICATION

The priority benefit of Korean patent application No. 10-10-2011-0049707 filed May 25, 2011, the entire disclosure of which is incorporated herein by reference, is claimed.

### BACKGROUND OF THE INVENTION

1. Technical Field

The present invention relates to a gas separation membrane which is used to selectively separate carbon dioxide from a gas mixture including carbon dioxide and hydrogen in a DME production process, and to a gas separation membrane module including the same.

2. Description of the Related Art

Processes of selectively separating specific a gas using a gas separation membrane having solubility for the specific gas are variously used in the field of energy and chemical industries. Particularly, in order to use hydrogen as an energy source or as a raw material for chemical processes, a gas separation membrane is increasingly used in a natural gas reforming reaction, in the process of concentrating methane from biogas, and in the process of separating a highly-condensed hydrocarbon compound or carbon dioxide, and the like.

Meanwhile, 97% of the energy consumed in Korea is imported. Particularly, since 84% of the consumed energy is taken up by fossil fuels which cause environmental pollution, Korea is classified as a nation discharging a large amount of greenhouse gas which causes global warming. Therefore, in order to overcome such a problem, it is keenly required to develop novel alternative energy sources which can reliably and continuously provide energy and can solve environmental problems.

Since dimethyl ether (CH₃—O—CH₃, hereinafter referred to as “DME”), which is a clean fuel, has a cetane number which can be applied to diesel engines, it can increase the efficiency of an engine and satisfy the environmental regulations for new ultra-low emission vehicles (ULEVs). Therefore, DME is attracting considerable attention as a high-efficiency alternative energy source for the future.

In 2009, the Korea Gas Corporation developed a technology of producing a DME catalyst and a process of producing DME in an amount of 10 tons per day, for example, a process of directly producing DME from a synthesis gas of carbon dioxide and hydrogen. Furthermore, the Korea Gas Corporation commercialized a technology of constructing a large-scale DME plant in undeveloped small and middle gas fields overseas. However, the process developed by the Korea Gas Corporation was not able to become compact in terms of scale because the existing plants such as a separator and the like have applied except a catalyst and a reactor to this process. Thus, in order to strengthen the competitiveness that is supposed to be brought about the commercialization of a DME plant, it is required to make process equipment compact to reduce the investment in construction investment as well as management and maintenance expenses.

Particularly, since the rate of a separator in the total DME plant equipment is very high and the energy required to perform a separation/refining process is about 40% of the total energy used by a process, energy consumption is very high. Moreover, recently, with the rise of the problem of global warming, it has been required to develop a separation process for treating unreacted carbon dioxide occurring during a DME production process.

An example of a conventional separation process used in a DME production process is the absorption method, in which is absorbed unreacted carbon dioxide by used a chemical absorber (methanol). However, this kind of absorption method, as described above, is problematic in that large-scale equipment is used, and in that energy consumption is very high because circulatory operations must be performed several times and a large-size refrigerator must be operated in order to improve the productivity and purity of DME. Further, the absorption method is problematic in that the safety of methanol, which is harmful to the human body, must be controlled. Thus, when a proper absorber cannot be used in the DME production process, the scale of equipment or the consumption of energy can increase in geometrical progression. Therefore, in order to strengthen the competitiveness in the DME production process, it is necessarily required to develop a separator or a separation method, which is competitive in the separation/treatment of unreacted carbon dioxide from synthesis gas.

Meanwhile, in large-scale DME production processes, the height of a DME plant is determined depending on the height of an absorption tower used to treat carbon dioxide. Recently, in order to make the DME production process compact, research into replacing an absorption tower process with a separation membrane process as a post-process of a tri-reformer for preparing synthesis gas has been actively attempted.

Compared to a conventional separation membrane process, this separation membrane process is advantageous in that a process of separating unreacted carbon dioxide is conducted on a small scale, it is easy to operate equipment, and it is possible to separate a mixture without phase transition. As a result, this separation membrane process is considered to be an environment-friendly process that assures process reliability, space efficiency and process safety because it requires low installation and operation costs and its energy consumption is very low compared to the conventional absorption or adsorption methods.

The core of the separation membrane process is to constitute a multi-stage control system including: a separation membrane for recovering unreacted carbon dioxide, a separation membrane module including the separation membrane, and a separation module assembly including the separation membrane modules.

In a conventional separation membrane process, research has generally been focused on a separation membrane material for recovering carbon dioxide, the separation membrane material being used to separate only carbon dioxide from synthesis gas such as carbon dioxide/methane, carbon dioxide/hydrocarbon or the like in a petrochemical process. However, research into separating carbon dioxide from a gas mixture of carbon dioxide and nitrogen has been earnestly attempted after global warming became an issue in 1990.

As the separation membrane material used to separate carbon dioxide, a polymer membrane, an inorganic membrane, a metal membrane, a ceramic membrane and the like were developed. Among these, the ceramic and metal membranes can be applied to exhaust gas without temperature control. They have high gas permeability and selectivity, but are difficult to form into a thin film and to impart a fine form thereto. Therefore, they cannot be formed into a module.

Meanwhile, as the gas separation membrane module used to separate carbon dioxide, Delsep, manufactured by Delta Project Corporation in Canada, GASEP, manufactured by Envirogenics System in the U.S.A, or the like, which is used to refine natural gas by separating carbon dioxide from a gas mixture of carbon dioxide and methane, is used. Further, Air Product Corporation is doing research into this gas separation membrane module. In Japan, research into carbon dioxide separation at high temperature has been conducted for 8 years from 1993 to 2000 using high-budget as a part of an environmental technology development program by the New Energy & Industrial Technology Development and Organization (NEDO). Even in DOE, NETL, PCAST in U.S.A and UCADI in Europe, stimulated by the development of high-temperature carbon dioxide/nitrogen ceramic separation membrane technology in Japan, research into high temperature carbon dioxide separation is being led by the government.

Patent document 1 (Japanese Unexamined Patent Publication No. 09202615) discloses a method of performing high-temperature separation using a zeolite material. However, this method is problematic in that the occurrence of defects cannot be prevented and the area of a membrane per unit volume is not large because the zeolite material has not been commercialized although it can be used at high temperature.

Patent document 2 (Japanese Unexamined Patent Publication No. 21029676) discloses a method of removing carbon dioxide using a palladium (Pd) alloy having selectivity for hydrogen. This method is advantageous in that it has high selectivity and can be applied at high temperature, but is disadvantageous in that the palladium (Pd) alloy used as a raw material of a membrane is expensive, pretreatment is difficult, and the ability to resist the entry of impurities into the membrane material is not high.

Korea Institute of Energy Research is preparing a test for the effectiveness of a zeolite separation membrane of 10 Nm³/h. Patent document 3 (Korean Unexamined Patent Publication No. 2006-0071686) discloses a method of using such a FAU zeolite.

Patent document 4 (Korean Examined Patent Publication No. 0562043) discloses a method of performing high temperature separation using a hollow fiber-type metal separation membrane, but does not disclose a technology for gas separation.

In addition, Patent document 5 (Korean Unexamined Patent Publication No. 2006-0085845) discloses a method of separating carbon dioxide/hydrogen using high permeability of the microporous structure of a heat-resistant polymer obtained in the process of producing polybenzoxide.

Meanwhile, research to separate carbon dioxide/hydrogen gas using a commercially-available polymer membrane is also ongoing. However, there is a problem in that the separation efficiency of the polymer membrane is low because the selectivity of the polymer membrane for carbon dioxide/hydrogen gas does not exceed 4.

Patent document 6 (U.S. Pat. No. 4,762,543) discloses examples of the use of the above-mentioned polymer membrane. However, the commercialization of the polymer membrane is not accompanied by many advantages of the polymer membrane because the selectivity of the polymer membrane for carbon dioxide is low as well as a process of decreasing temperature and recovering heat is additionally required.

Patent document 7 (U.S. Pat. No. 5,049,167) discloses a method of increasing the selectivity of carbon dioxide/hydrogen by the interfacial polymerization of polyamide on a polymer composite membrane. However, this method can be applied to a process of separating hydrogen from a gas mixture of carbon dioxide and hydrogen, but it is difficult to apply it to the selective removal of only carbon dioxide from the gas mixture of carbon dioxide, hydrogen and carbon monoxide in DME process.

### SUMMARY OF THE INVENTION

Accordingly, the present invention has been devised to solve the above-mentioned problems, and an object of the present invention is to provide a gas separation membrane whose permeation selectivity for carbon dioxide is higher than the permeation selectivity for hydrogen in order to remove unreacted carbon dioxide in a DME production process.

Another object of the present invention is to provide a module including the gas separation membrane.

In order to accomplish the above objects, the present invention provides a gas separation membrane for a DEM production process, including: a porous support having a carbon dioxide permeability of more than 300 GPU (GPU=1×10⁻⁶ cm³/cm²·sec·cmHg) and an inner diameter of 100˜1000 μm; and a composite membrane provided on an inner or outer surface of the porous support and coated with a separating material having a permeation selectivity of carbon dioxide/hydrogen of 4 or more.

In this case, the gas separation membrane can effectively separate and remove only carbon dioxide from a gas mixture of carbon dioxide and hydrogen produced during a DME production process in which the three components of carbon dioxide, hydrogen and carbon monoxide are all present.

### BRIEF DESCRIPTION OF THE DRAWINGS

The above and other objects, features and advantages of the present invention will be more clearly understood from the following detailed description taken in conjunction with the accompanying drawing, in which:

FIG. 1 is an electron microscope photograph showing the section of a composite membrane constituting a gas separation membrane according to the present invention.

### DESCRIPTION OF THE PREFERRED EMBODIMENTS

Hereinafter, preferred embodiments of the present invention will be described in detail with reference to the attached drawing.

Manufacture of a Porous Support

Concretely, a porous support must have excellent mechanical properties in order to maintain the strength of a composite membrane operated at high pressure, and must have low resistance in order to improve the performance of a composite membrane.

The porous support is manufactured by the steps of: preparing a dope solution including a support forming material, a solvent and an additive; and wet-spinning the dope solution at high speed and then drying the wet-spun dope solution to form a hollow fiber for forming support.

The support forming material is a material which has low permeation resistance to gases such as carbon dioxide or the like and is a material onto the surface of which a separating material can easily be applied. It is most preferred that polyetherimide be used as the support forming material, but this is not limited thereto. In addition to polyetherimide, a polymer material, such as polysulfone, polycarbonate, polyimide, polyphenylene oxide or the like, may be used as the support forming material.

Further, the solvent serves to uniformly dissolve and disperse the additive and the support forming material. Examples of the solvent may include N-methylpyrrolidone, N,N-dimethylformamide, N,N-dimethylacetamide and the like. Most preferably, the solvent may be N-methylpyrrolidone.

The additive serves to form a uniform polymer solution in the dope solution, and includes a first additive and a second additive. For example, the first additive serves to control the porosity of the porous support, and may be an organic solvent which has a low boiling point, is a nonsolvent to a polymer and has an ultrahigh solubility in water to such a degree that it is infinitely diluted in water at room temperature. Typical examples of the organic solvent may include tetrahydrofuran and the like. Further, the second additive serves to increase the phase separation speed during the formation of a film to form micropores, and may be an organic solvent in which a polymer is not miscible and may have ultrahigh solubility in water to such an extent that it can be infinitely diluted in water at room temperature. Typical examples of the organic solvent may include methanol, ethanol, propanol and the like.

In the present invention, the solvent may be included in the dope solution in an amount of 150˜350 parts by weight, preferably 200˜300 parts by weight, based on 100 parts by weight of the support forming material. When the amount of the solvent is less than 150 parts by weight or more than 350 parts by weight, it is difficult to produce a uniform hollow fiber, and the permeability of carbon dioxide to the porous support becomes low.

Further, it is most preferred that the relative weight ratio of the solvent: the first additive: the second additive in the dope solution be 2:1˜2:1, for example, 2:1:1. When the weight ratio of the first additive is more than 2 or the weight ratio of the second additive is more than 1, the stability of the dope solution used to manufacture a gas separation membrane deteriorates. Further, when the weight ratio of the first additive is less than 1 or the weight ratio of the second additive is less than 1, it is difficult for a separating material to be uniformly applied.

Further, in the present invention, the process of spinning the dope solution at high speed to form a hollow fiber includes the steps of removing air bubbles from the dope solution using a vacuum pump and then removing heterogeneous materials from the dope solution using a fibrous filter or a metal sintered filter when transporting the dope solution into a gear pump by applying a pressure into a mixing tank using nitrogen gas. The process of spinning the dope solution at high speed to form a hollow fiber further includes the steps of spinning the transported dope solution into water (nonsolvent) through a spinning nozzle at a flow rate of 5˜10 cc/min to form a hollow fiber.

In this case, the spinning nozzle has a double nozzle structure. The dope solution is ejected through the outer nozzle of the double nozzle structure, and a coagulant is ejected at a flow rate of 2˜5 mL/min through the inner nozzle of the double nozzle structure, thus forming a hollow fiber. Here, the diameter of the outer nozzle of the double nozzle structure is 1.2 mm, and the inner diameter and outer diameter of the inner nozzle thereof are 0.4 mm and 0.8 mm, respectively. In this spinning process, water is generally used as the coagulant.

Subsequently, the formed hollow fiber is rolled on a rotary bobbin, and is then dipped in a washing tank filled with water for 120 hours to remove a very small amount of organic compound (for example, a solvent) from the hollow fiber. The washed hollow fiber moves to a dryer, and is than dried at room temperature to 100° C., preferably at a temperature of 50° C. to 80° C.

In this way, a porous support including a hollow fiber bundle having 100˜50,000 strands can be obtained. The inner diameter of a hollow fiber for a conventional gas separation membrane is 50˜700 μm, whereas the inner diameter of the hollow fiber of the porous support obtained by the method of the present invention is 100˜1000 μm, preferably, 700˜1000 μm, more preferably 800 μm, and the outer diameter thereof is 1200 μm. Therefore, it is possible to solve the problem of the flow of condensable gas being disturbed by condensation when the condensable gas flows into a hollow fiber membrane.

Further, the porous support may have a porosity of 90 vol % or less, preferably, 40˜80 vol %, based on the total volume of the porous support.

Manufacture of a Composite Membrane

Further, in the present invention, in order to improve the permeation selectivity of carbon dioxide, the inner and outer surfaces of the porous support of the present invention are coated with a separating material having a permeation selectivity of carbon dioxide/hydrogen of 4 or more to form a composite membrane.

The separating material may be co-polymer material which can be continuously and thinly applied onto the surface of the porous support. Concretely, it is preferred that the separating material consist of a glassy co-polymer material including silicon atom or ethylene oxide, having a high carbon dioxide permeation rate of more than 100 barrers (1 barrer=10⁻¹⁰ cm³/cm²˜sec·cmHg), and a low hydrogen permeation rate. Typical examples of the co-polymer material may include polydimethylsiloxane, a polyethyleneoxide-amide copolymer, a polyethyleneoxide-urethane copolymer, a polyethyleneoxide-urea copolymer, a polyethyleneoxide-imide copolymer and a polyethyleneoxide-ester copolymer, more preferably, a polyethyleneoxide-urethane copolymer, a polyethyleneoxide-urea copolymer, a polyethyleneoxide-imide copolymer and a polyethyleneoxide-ester copolymer.

Further, in order to form a multi-layered thin film on the porous support, the selection of a coating solvent is important. In the present invention, a solvent, which has high volatility and low surface tension and which can be easily removed after coating, may be used as the coating solvent. Typical examples of the coating solvent may include ethanol, isopropyl alcohol, butanol, pentane, hexane, heptane, and combinations thereof.

In this case, the carbon oxide permeation selectivity of a composite membrane to a gas mixture can be appropriately adjusted depending on the combination ratio of the separating material applied on the porous support and the coating solvent used when the separating material is applied. For example, in the present invention, it is preferred that a coating solution having a concentration (weight ratio?) of 2˜10% be used such that the carbon dioxide permeability of the composite membrane is about 300 GPU (GPU=1×10⁻⁶ cm³/cm²·sec·cmHg) or more and the permeation selectivity of carbon dioxide/hydrogen is 4 or more. In this case, the gas selectivity can be obtained by dividing the amount of transmitted carbon dioxide by the amount of transmitted hydrogen.

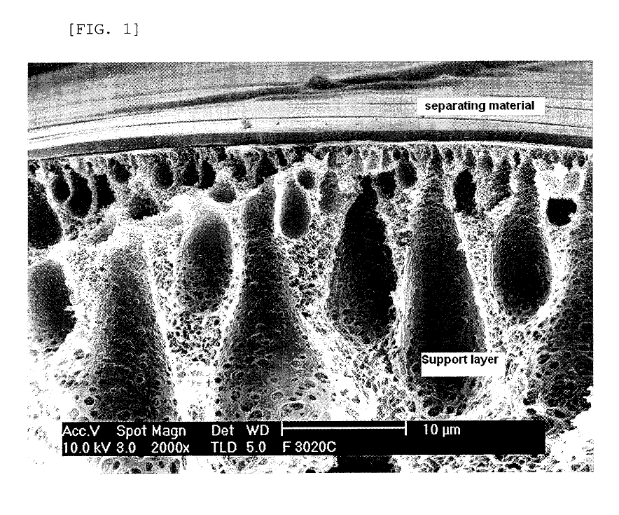

Subsequently, in the present invention, a solvent including the separating material is prepared, and then a porous support is dipped in the solvent for 5 seconds or more at room temperature and then dried to form a composite membrane including the porous support coated with the separating material (refer to FIG. 1). When the porous support is dipped for 5 seconds or less, the coating film may be rendered defective.

Concretely, the gas permeability of the gas separation membrane may be represented by multiplication of diffusivity and solubility, which means that the gas permeability is improved as the solubility increases. In a typical gas separation membrane, generally, the permeation speed of hydrogen is faster than that of carbon dioxide. The reason for this is because the gas separation membrane is generally formed of a glassy polymer, and the diffusivity of the glassy polymer plays an important role in the difference in permeation speed between gases. In the polymer and solvent, since carbon dioxide has high condensability, the solubility of carbon dioxide is higher than that of hydrogen.

The present invention relates to a gas separation membrane whose carbon dioxide solubility is higher than the hydrogen solubility thereof. In other words, it relates to a gas separation membrane whose carbon dioxide permeability is higher than its hydrogen permeability. Here, a glassy polymer is used to make a porous support which does not influence selective separation. A thermoplastic polymer, whose the dissolving selectivity of carbon dioxide (which is a condensable gas compared to hydrogen) is higher than that of hydrogen, which have a high fractional free volume and which has low crystallinity, is used as a separating material for coating the porous support.

Based on the relative size of molecules, the diffusivity of carbon dioxide is higher than that of methane, and is lower than that of hydrogen. A separating material having high diffusion selectivity in the separation of carbon dioxide/hydrogen can be obtained by the design of a relatively rigid polymer having a high glass transition temperature. However, high carbon dioxide permeability can be secured by increasing the fractional free volume in a polymer membrane material. For example, although a separating material whose has high solubility selectivity for carbon dioxide or light gas is employed in the separation of carbon dioxide/hydrogen, it is generally disadvantageous in terms of diffusion selectivity, and it is able to be used to separate carbon dioxide/hydrogen whose sizes of molecular are not greatly different from each other. The present invention is based on the relationship between the structure and transmissive properties of a polymer having high permeability to carbon dioxide and high selectivity for carbon dioxide or light gas. Therefore, the present invention is focused on a separating material which can obtain high permeation selectivity depending on the solubility selectivity obtained in this way.

That is, when the amount of a functional group in the polyethyleneoxide compound used as a separating material in the present invention is properly adjusted, a separation membrane having optimal carbon dioxide permeability and carbon dioxide/hydrogen selectivity can be provided. For example, in order to prevent the crystallization of the polyethyleneoxide compound which substantially deteriorates gas permeability, a functional group, such as an ethyleneoxide group or a polyethyleneoxide group, is included in a polymer including the polyethyleneoxide compound in an amount of 30˜70 wt %. When the amount of the functional group is less than 30 wt %, permeability of carbon dioxide is very low, and when the amount thereof is more than 70 wt %, the mechanical strength of a gas separation membrane becomes low.

Manufacture of a Module Including a Gas Separation Membrane

Further, the present invention provides a module including the manufactured gas separation membrane. In this case, a hollow fiber bundle of 100˜50,000 strands is inserted into a housing of the module, and both ends of the module are blocked by a potting agent. A gas mixture is introduced into the hollow fiber bundle in the module, and transmitted gas is discharged to the outside of the module.

In this case, the housing of the module including the gas separation membrane of the present invention may be made of anodized aluminum, carbon steel or stainless steel, which has excellent mechanical properties, high chemical durability and excellent adhesivity to a potting agent.

As described above, the present invention provides a gas separation membrane which includes a porous support having high carbon dioxide permeability and a composite membrane containing a separating material having a permeation selectivity of carbon dioxide/hydrogen of 4 or more, and whose carbon dioxide permeability is higher than the hydrogen permeability thereof. The present invention provides a module including the gas separation membrane. The gas separation membrane of the present invention is advantageous in that the energy consumption in the DME process can be reduced and in that it is possible to secure process reliability, space efficiency and process safety.

Hereinafter, the present invention will be described in more detail with reference to the following Examples and Comparative Examples. These Examples are set forth to illustrate the present invention, and the scope of the present invention is not limited thereto.

### Example 1

### (a) Preparation of a Hollow Fiber Membrane

20 g of polyetherimide (Sabic-IP Corp., Ultem™), 20 g of tetrahydrofuran (first additive) and 20 g of ethanol (second additive) were sequentially slowly dropped into 40 g of N-methylpyrrolidone (solvent) while the solvent was stirred, thus preparing a uniform dope solution. Subsequently, air bubbles were removed from the dope solution for 24 hours at room temperature and reduced pressure, and then foreign materials were removed from the dope solution using a 60 μm filter. Subsequently, the dope solution was spun at a flow rate of 7 cc/min at a temperature of 60° C. using a cylinder pump. Here, the air gap is 10 cm, a double spinnerette was used, and water was used as a coagulant. Further, the inner and outer diameters of the inner nozzle of the double spinnerette were 0.4 mm and 0.8 mm, respectively, and the diameter of the outer nozzle of the double spinnerette was 1.2 mm. Subsequently, the temperatures of the external coagulation tank were set 5° C. and 15° C., respectively to undergo a phase transition procedure, and then a obtained hollow fiber was rolled, cut and washed with flowing water for 2 days to remove the solvent and additives remaining in the hollow fiber. Subsequently, the hollow fiber was dipped in methanol for 3 hours or more to substitute the water remaining in the compact separation layer thereof with methanol, and was further dipped in n-hexane for 3 hours to substitute n-hexane for the methanol, and was then dried for 3 hours or more at 70° C. under a vacuum atmosphere to prepare the hollow fiber membrane for a porous support. The inner diameter of the prepared hollow fiber membrane was about 800 μm, and the outer diameter thereof was about 1200 μm.

### (b) Manufacture of a Gas Separation Membrane

Subsequently, the hollow fiber membrane prepared in step (a) was unrolled from a bobbin, and was then dipped in a 5% polydimethylsiloxane coating solution (solvent: n-hexane) for 5 seconds or more at room temperature while maintaining constant tension to manufacture a gas separation membrane including a composite membrane coated with a separating material.

### (c) Evaluation of the Performance of a Gas Separation Membrane Module

Three modules were manufactured using the manufactured gas separation membrane module, and the average gas permeability of the modules was measured at room temperature and a pressure of 1˜4 atms using 99.9% of a gas mixture of oxygen and nitrogen and 99.9% of a gas mixture of carbon dioxide and hydrogen. In this case, the gas permeability thereof was measured using a mass flow meter, and the results thereof are given in Table 1 below. Each of the modules included a hollow fiber membrane of 1000 strands. The gas permeation unit (GPU) of the composite membrane is 10⁻⁶×cm³/cm²·sec·cmHg.

TABLE 1

| | Carbon dioxide | Hydrogen | Permeation selectivity |
|---|---|---|---|
| Pressure | permeability | permeability | of carbon dioxide/ |
| (bar) | (P_{CO2}, GPU) | (P_{H2}, GPU) | hydrogen (P_{CO2}/P_{H2}) |
| 1 | 320 | 75 | 4.3 |
| 2 | 370 | 77 | 4.8 |
| 3 | 380 | 80 | 4.8 |
| 4 | 400 | 81 | 4.9 |
| | Oxygen | Nitrogen | Permeation selectivity |
| Pressure | permeability | permeability | of oxygen/nitrogen |
| (bar) | (P_{O2}, GPU) | (P_{N2}, GPU) | (P_{O2}/P_{N2}) |
| 1 | 65 | 31 | 2.1 |
| 2 | 68 | 32 | 2.1 |
| 3 | 69 | 33 | 2.1 |
| 4 | 69 | 33 | 2.1 |

### Example 2

The hollow fiber membrane prepared in the same manner as in Example 1 was unrolled from a bobbin, and was then dipped in a 5% polyethyleneoxide-urethane coating solution (solvent: n-butanol) for 5 seconds or more at room temperature while maintaining constant tension to manufacture a gas separation membrane including a composite membrane coated with a separating material. A gas separation membrane module was manufactured using the manufactured gas separation membrane, and then the performance of the gas separation membrane module was evaluated in the same manner as in Example 1. The results thereof are given in Table 2 below.

TABLE 2

| | Carbon dioxide | Hydrogen | Permeation selectivity |
|---|---|---|---|
| Pressure | permeability | permeability | of carbon dioxide/ |
| (bar) | (P_{CO2}, GPU) | (P_{H2}, GPU) | hydrogen (P_{CO2}/P_{H2}) |
| 1 | 140 | 17.7 | 7.9 |
| 2 | 148 | 18.7 | 7.9 |
| 3 | 158 | 19.8 | 8.0 |
| 4 | 162 | 20.2 | 8.0 |
| | Oxygen | Nitrogen | Permeation selectivity |
| Pressure | permeability | permeability | of oxygen/nitrogen |
| (bar) | (P_{O2}, GPU) | (P_{N2}, GPU) | (P_{O2}/P_{N2}) |
| 1 | 9.0 | 8.2 | 1.1 |
| 2 | 9.6 | 8.7 | 1.1 |
| 3 | 11.2 | 9.3 | 1.2 |
| 4 | 11.4 | 9.5 | 1.2 |

### Comparative Example 1

A hollow fiber membrane was prepared in the same manner as in Example 1, except that polysulfone was used instead of polyetherimide. In this case, the inner and outer diameters of the prepared hollow fiber membrane were about 200 μm and about 400 μm, respectively. Subsequently, the prepared hollow fiber membrane was unrolled from a bobbin, and was then dipped into a 5% dimethyl-methylphenylmethoxysiloxane coating solution (solvent: n-hexane) at room temperature while maintaining constant tension to manufacture a gas separation membrane including a composite membrane coated with a separating material. A gas separation membrane module was manufactured using the manufactured gas separation membrane, and then the performance of the gas separation membrane module was evaluated in the same manner as in Example 1. The results thereof are given in Table 3 below.

TABLE 3

| | Carbon dioxide | Hydrogen | Permeation selectivity |
|---|---|---|---|
| Pressure | permeability | permeability | of carbon dioxide/ |
| (bar) | (P_{CO2}, GPU) | (P_{H2}, GPU) | hydrogen (P_{CO2}/P_{H2}) |
| 1 | 140 | 98 | 1.4 |
| 2 | 154 | 108 | 1.4 |
| 3 | 162 | 110 | 1.5 |
| 4 | 172 | 115 | 1.5 |
| | Oxygen | Nitrogen | Permeation selectivity |
| Pressure | permeability | permeability | of oxygen/nitrogen |
| (bar) | (P_{O2}, GPU) | (P_{N2}, GPU) | (P_{O2}/P_{N2}) |
| 1 | 36 | 12 | 3.0 |
| 2 | 38 | 12.3 | 3.1 |
| 3 | 40 | 12.5 | 3.2 |
| 4 | 41 | 12.8 | 3.2 |

### Comparative Example 2

The performance of a gas separation membrane module was evaluated in the same manner as in Comparative Example 1, except that a commercially-available polyimide single membrane module having a carbon dioxide permeability of 150 GPU was used instead of the gas separation membrane module manufactured in Comparative Example 1. The results thereof are given in Table 4 below.

TABLE 4

| | Carbon dioxide | Hydrogen | Permeation selectivity |
|---|---|---|---|
| Pressure | permeability | permeability | of carbon dioxide/ |
| (bar) | (P_{CO2}, GPU) | (P_{H2}, GPU) | hydrogen (P_{CO2}/P_{H2}) |
| 1 | 140 | 400 | 0.35 |
| 2 | 160 | 430 | 0.4 |
| 3 | 170 | 450 | 0.4 |
| 4 | 180 | 500 | 0.4 |

As given in Tables 3 and 4, it can be seen that the gas separation membrane of Comparative Example 1 has a low permeation selectivity of carbon dioxide/hydrogen of less than 4 because a general rubber-like polymer such as dimethyl-methylphenylmethoxysiloxane is used as the separating material applied on the porous support. Further, it can be seen that, in the case of Comparative Example 2 in which a conventional polyimide single membrane module having a carbon dioxide permeability of 150 GPU was used, the gas separation membrane of Comparative Example 2 has a very low permeation selectivity of carbon dioxide/hydrogen of less than 1. Therefore, it can be ascertained that it is difficult to apply conventional gas separation membrane modules to the gas separation membrane module for removing unreacted carbon dioxide in the DME production process according to the present invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A gas separation membrane for a DEM production process, comprising:
a porous support having a carbon dioxide permeability of more than 300 GPU (GPU=1×10⁻⁶ cm³/cm²·sec·cmHg) and an inner diameter of 100˜1000 μm; and
a composite membrane provided on an inner or outer surface of the porous support and coated with a separating material having a permeation selectivity of carbon dioxide/hydrogen of 4 or more.

2. The gas separation membrane according to claim 1, wherein the porous support is manufactured by a process comprising the steps of: preparing a dope solution including a support forming material, a solvent and an additive; and wet-spinning the dope solution at high speed and then drying the wet-spun dope solution to form a hollow fiber for the support.

3. The gas separation membrane according to claim 2, wherein the support forming material is a polymer material selected from the group consisting of polysulfone, polycarbonate, polyimide, polyetherimide and polyphenyleneoxide.

4. The gas separation membrane according to claim 2, wherein the solvent is N-methylpyrrolidone, N,N-dimethylformamide or N,N-dimethylacetamide.

5. The gas separation membrane according to claim 2, wherein the additive includes a first additive which is tetrahydrofuran and a second additive which is any one selected from the group consisting of methanol, ethanol and propanol.

6. The gas separation membrane according to claim 4, wherein the solvent is included in the dope solution in an amount of 150˜350 parts by weight based on 100 parts by weight of the support forming material.

7. The gas separation membrane according to claim 4, wherein a relative weight ratio of the solvent: the first additive: the second additive in the dope solution is 2:1˜2:1.

8. The gas separation membrane according to claim 1, wherein the porous support has a porosity of 40˜80 vol % based on a total volume of the porous support.

9. The gas separation membrane according to claim 1, wherein the separating material includes a co-polymer material including silicon atom and ethylene oxide and having a high carbon dioxide permeation rate of more than 100 barrers (1 barrer=10⁻¹⁰ cm³/cm²·sec·cmHg).

10. The gas separation membrane according to claim 9, wherein the co-polymer material is any one selected from the group consisting of polydimethylsiloxane, a polyethyleneoxide-amide copolymer, a polyethyleneoxide-urethane copolymer, a polyethyleneoxide-urea copolymer, a polyethyleneoxide-imide copolymer and a polyethyleneoxide-ester copolymer.

11. The gas separation membrane according to claim 1, wherein the coating of the separating material is performed by dipping the porous support into the solvent containing the separation material.

12. A gas separation membrane module for DME production process, comprising the gas separation membrane of claim 1.

13. The gas separation membrane module according to claim 12, comprising a housing made of any one selected from the group consisting of anodized aluminum, carbon steel and stainless steel,
wherein a gas separation membrane consisting of composite membrane including a porous support having a hollow fiber bundle of 100˜50,000 strands is inserted into the housing.

14. The gas separation membrane module according to claim 12, wherein the module is used to selectively separate and remove carbon dioxide from a gas mixture of carbon dioxide and hydrogen occurring during a process of producing DME.
